(19) United States
(12) Patent Application Publication
(10) Pub. No.: US 2025/0354777 A1
(43) Pub. Date: Nov. 20, 2025

(54) Insect Control Gun Device

(71) Applicant: Steve Howard, Olathe, CO (US)

(72) Inventor: Steve Howard, Olathe, CO (US)

(21) Appl. No.: 19/010,724

(22) Filed: Jan. 6, 2025

Related U.S. Application Data
(60) Provisional application No. 63/649,620, filed on May 20, 2024.

(51) Int. Cl. A01M 3/00; F41B 11/50; F41B 11/62; F41B 11/723

(52) U.S. Cl. CPC A01M 3/00; F41B 11/50; F41B 11/62; F41B 11/723

(57) ABSTRACT

An insect control gun device is provided, the device is designed to repel and eliminate insects with minimal effort. The device comprises a firearm-shaped body with a handle featuring dual triggers for operating a high-pressure CO2 stream from the main barrel and an insect repellent spray from a secondary barrel. The main barrel incorporates adjustable LED lighting to attract insects, while the secondary barrel dispenses repellent from a securely attached, transparent reservoir. A replaceable CO2 cartridge powers both the insect-killing and repellent-dispensing functions, controlled by a pressure valve system.

### CROSS-REFERENCE TO RELATED APPLICATION

The present application claims priority to, and the benefit of, U.S. Provisional Application No. 63/649,620, which was filed on May 20, 2024, and is incorporated herein by reference in its entirety.

### FIELD OF THE INVENTION

The present invention relates generally to the field of insect-killing devices. More specifically, the present invention relates to an insect control gun device comprising a firearm-shaped body with dual triggers that operate a high-pressure CO2 stream and an insect repellent spray from separate barrels. The device features an LED light for attracting insects and is powered by a replaceable CO2 cartridge. Accordingly, the present disclosure makes specific reference thereto. Nonetheless, it is to be appreciated that aspects of the present invention are also equally applicable to other like applications, devices, and methods of manufacture.

### BACKGROUND

Dealing with insects such as flies, mosquitoes, and other pests is a persistent issue that affects both indoor and outdoor environments. These pests are not only a nuisance but also carry significant health risks. Flies and mosquitoes can land on food, beverages, and kitchen surfaces, leading to contamination and the potential spread of illnesses such as foodborne diseases and mosquito-borne infections like malaria or dengue. Traditional pest control methods, including fly swatters, insect lamps, adhesive traps, and aerosol sprays, provide varying degrees of success but come with notable drawbacks. Fly swatters require direct physical effort and often leave messy residues that must be cleaned. Insect lamps and adhesive traps can attract pests but result in waste disposal challenges and may not address fast-moving insects effectively. Aerosol sprays, while widely used, often lack precision, create chemical residues in the environment, and may require users to vacate the area for safety reasons. These existing solutions are often inconvenient, ineffective, or unhygienic, highlighting the demand for a more advanced, efficient, and user-friendly method of insect control.

Therefore, there exists a long-felt need in the art for an insect control gun that provides a convenient and effective method of eliminating insects. There also exists a long-felt need in the art for an insect control gun that reduces the mess associated with traditional methods of pest control. Moreover, there exists a long-felt need in the art for an insect control gun that integrates multiple functionalities, such as repelling and disintegrating insects, into a single device.

The subject matter disclosed and claimed herein, in one embodiment thereof, comprises an insect control gun device. The device is comprised of an insect control gun device designed to repel and eliminate insects with minimal effort. The device comprises a firearm-shaped body with a handle featuring dual triggers for operating a high-pressure CO2 stream from the main barrel and an insect repellent spray from a secondary barrel. The main barrel incorporates adjustable LED lighting to attract insects, while the secondary barrel dispenses repellent from a securely attached, transparent reservoir. A replaceable CO2 cartridge powers both the insect-killing and repellent-dispensing functions, controlled by a pressure valve system.

In this manner, the insect control gun device of the present invention accomplishes all the foregoing objectives and provides a device that resembles a firearm for user convenience and ease of handling. The integration of CO2 cartridges enables the emission of a high-pressure air stream to repel or disintegrate insects efficiently, eliminating the need for direct contact or messy cleanups. Additionally, a secondary dispensing mechanism allows users to release insect repellent in a targeted manner. By combining these features with optional components such as an LED light for attracting insects and a switch for controlling functionality, the device offers a streamlined, effective, and multi-purpose solution to insect control challenges.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an insect control gun device. The insect control gun device is a pest control tool designed for efficient insect elimination with minimal effort. The device features a firearm-shaped body constructed from lightweight, durable materials, such as reinforced polymers or anodized aluminum.

The body comprises a handle with a textured grip for a secure hold in various conditions. The handle incorporates two independently functioning triggers: a primary trigger that releases a high-pressure CO2 burst through the main barrel and a secondary trigger that operates an insect repellent dispensing mechanism in the secondary barrel. A trigger lock mechanism provides added safety by preventing unintentional activation.

The main barrel dispenses a concentrated high-velocity CO2 stream, capable of disintegrating insects. It includes an LED light at the tip, featuring adjustable brightness and wavelength settings, such as UV light, to enhance insect attraction. These settings are controlled by a toggle button.

The secondary barrel is designed for dispensing insect repellent fluid stored in an attachable reservoir. The reservoir, securely connected via a locking mechanism, is compatible with various formulations, including plant-based and synthetic insecticides. A nozzle at the barrel tip ensures a controlled spray, with adjustable options for spray angle and mist density.

A replaceable CO2 cartridge, housed within a dedicated compartment in the body, powers the device. The compartment includes a quick-release mechanism for easy cartridge replacement while ensuring secure seating during use. The CO2 cartridge operates both the high-pressure gas stream and the repellent dispensing system.

Activation of the primary trigger engages a mechanical linkage system to open a pressure control valve, releasing CO2 into the main barrel. The secondary trigger directs CO2 to pressurize the insect repellent reservoir, expelling the fluid as a fine spray through the nozzle.

The repellent reservoir features a transparent design for monitoring fluid levels and connects securely to the body to prevent leaks and contamination. The device also includes a user method, outlining steps for loading CO2 cartridges, attaching and filling the reservoir, configuring LED light settings, and activating the CO2 or repellent mechanisms for targeted pest control.

Accordingly, the insect control gun device of the present invention is particularly advantageous as it provides a device that resembles a firearm for user convenience and ease of handling. The integration of CO2 cartridges enables the emission of a high-pressure air stream to repel or disintegrate insects efficiently, eliminating the need for direct contact or messy cleanups. Additionally, a secondary dispensing mechanism allows users to release insect repellent in a targeted manner. By combining these features with optional components such as an LED light for attracting insects and a switch for controlling functionality, the device offers a streamlined, effective, and multi-purpose solution to insect control challenges. In this manner, the insect control gun device overcomes the limitations of existing insect control techniques and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an insect control gun device of the present invention with the insect repellent reservoir unattached to the body in accordance with the disclosed architecture;

FIG. 2 illustrates a side view of one potential embodiment of an insect control gun device of the present invention with the insect repellent reservoir attached to the body in accordance with the disclosed architecture;

FIG. 3 illustrates a side view of one potential embodiment of an insect control gun device of the present invention with the insect repellent reservoir unattached to the body in accordance with the disclosed architecture; and

FIG. 4 illustrates a flowchart of a method of using one potential embodiment of an insect control gun device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an insect control gun that provides a convenient and effective method of eliminating insects. There also exists a long-felt need in the art for an insect control gun that reduces the mess associated with traditional methods of pest control. Moreover, there exists a long-felt need in the art for an insect control gun that integrates multiple functionalities, such as repelling and disintegrating insects, into a single device.

The present invention, in one exemplary embodiment, is comprised of an insect control gun device. The insect control gun device is a pest control tool designed to eliminate insects efficiently with minimal effort. The device features a firearm-shaped body made from lightweight, durable materials such as reinforced polymers or anodized aluminum.

The body includes a handle with a textured grip, providing a secure hold in various conditions. The handle incorporates two independently functioning triggers, a primary trigger for releasing a high-pressure CO2 burst through the main barrel and a secondary trigger for operating an insect repellent dispensing mechanism in the secondary barrel. A trigger lock mechanism enhances safety by preventing accidental activation.

The main barrel emits a concentrated, high-velocity CO2 stream capable of disintegrating insects. At the tip of the barrel, an LED light with adjustable brightness and wavelength settings, including UV light, enhances insect attraction. These settings are managed via a toggle button.

The secondary barrel dispenses insect repellent fluid stored in an attachable reservoir. The reservoir is securely connected through a locking mechanism and supports various formulations, including plant-based and synthetic insecticides. The nozzle at the barrel tip ensures a controlled spray, with adjustable options for spray angle and mist density.

A replaceable CO2 cartridge housed in a dedicated body compartment powers the device. The compartment includes a quick-release mechanism for easy cartridge replacement while ensuring secure seating during operation. The CO2 cartridge drives both the high-pressure gas stream and the repellent dispensing system.

Engaging the primary trigger activates a mechanical linkage system that opens a pressure control valve, releasing CO2 into the main barrel. The secondary trigger routes CO2 to pressurize the repellent reservoir, expelling the fluid as a fine spray through the nozzle.

The repellent reservoir features a transparent design for monitoring fluid levels and connects securely to the body to prevent leaks and contamination. The device also includes a user method outlining steps for loading CO2 cartridges, attaching and filling the reservoir, configuring LED light settings, and activating the CO2 or repellent mechanisms for targeted pest control.

This insect control gun device is particularly advantageous due to its firearm-like design, providing user convenience and ease of handling. The integration of CO2 cartridges enables the emission of a high-pressure air stream for efficient insect control without direct contact or messy cleanups. The secondary dispensing mechanism allows for targeted application of insect repellent. With optional components like an LED light for insect attraction and a switch for controlling functionality, the device offers an effective, versatile solution to insect control challenges, addressing the limitations of existing methods and devices.

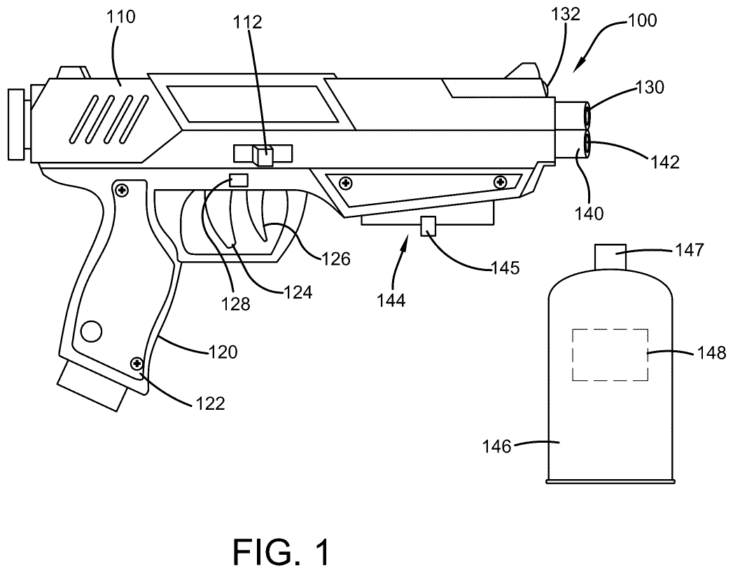

Referring initially to the drawings, FIG. 1 illustrates a side view of one potential embodiment of an insect control gun device 100 of the present invention with the insect repellent reservoir 146 unattached to the body in accordance with the disclosed architecture. The insect control gun device 100 is a pest control tool designed to repel and eliminate insects with minimal user effort. The body 110 of the device 100, which is preferably firearm-shaped, is constructed from durable, lightweight materials such as reinforced polymers or anodized aluminum.

The body 100 is comprised of a handle 120. The handle 120 may feature a textured grip area 122 made from thermoplastic elastomers or silicone overlays, providing a secure, non-slip hold even in wet or sweaty conditions. The handle 120 is comprised of two independently functioning triggers 124, 126. The primary trigger 124 controls the release of a high-pressure CO2 burst from the main barrel 130, as will be described more fully below. The secondary trigger 126 operates the insect repellent dispensing mechanism 170 located in the secondary barrel 140, as described more fully below. At least one trigger lock mechanism 128 can be integrated into the handle 120 for added safety, preventing unintentional activation of either or both triggers 124, 126.

The main barrel 130 projects a concentrated stream of CO2 outwards at high pressure, capable of disintegrating insects upon contact. At the tip of the main barrel 130, at least one LED light 132 is integrated, designed to attract insects toward the barrel 130 for accurate targeting. The LED light 132 may feature adjustable brightness settings and a wavelength-specific mode, such as UV light, to enhance its effectiveness against different types of insects. A toggle button 112 allows the user to configure the brightness and wavelength settings of the light 132.

Positioned beneath the main barrel 130, a secondary barrel 140 dispenses an insect repellent fluid 148 through a nozzle 142. The secondary barrel 140 connects directly to an attachable insect repellent reservoir 146, which serves as the fluid storage container for the insect repellent fluid 148. The insect repellent fluid 148 may include any type of insect repelling or insect-killing formulation, such as, but not limited to, plant-based repellents, chemical repellents, or synthetic insecticides.

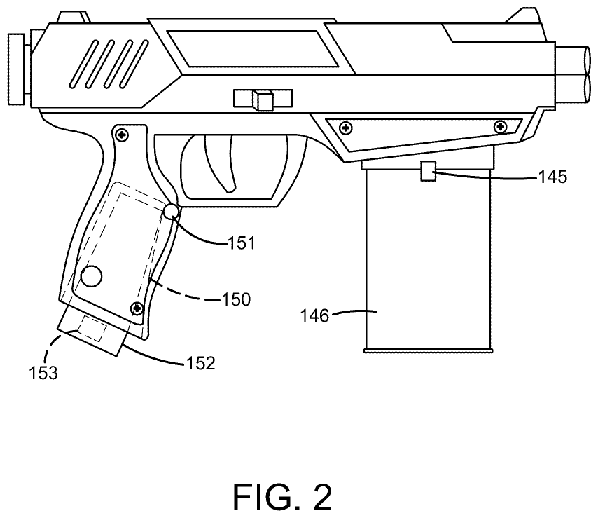

The reservoir 146 is securely and removably attached to the insect repellent reservoir receiving area 144, as seen in FIG. 2. The receiving area 144 includes a locking mechanism 145, which may be in the form of a threaded or snap-fit system that engages with at least one fastener 147 on the reservoir 146. This design ensures a reliable seal between the reservoir 146 and body 110.

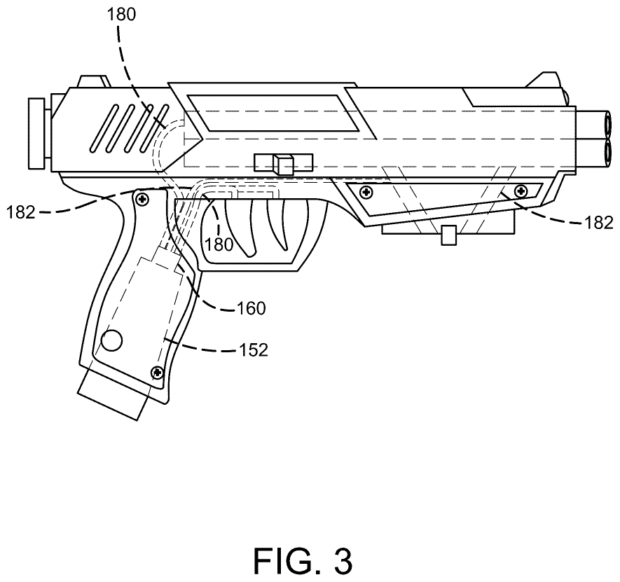

The device 100 is comprised of at least one replaceable cartridge 152 housed within the cartridge housing 150 (as seen in FIG. 2 and FIG. 3), which is integrated within some portion of the body 110. The cartridge 152 contains compressed CO2 153, which serves as the energy source for expelling the gas through the main barrel 130 and also powering a repellent propulsion system, which will be described more fully below. The housing includes at least one quick-release mechanism 151 in the form of a button or latch that allows the user to remove and replace the cartridge 152 and ensures that the cartridge 152 remains firmly seated within the housing 150 during operation of the device 100.

When the primary trigger 124 is pressed, the trigger 124 engages a mechanical linkage system 190 (as seen in FIG. 3) that opens the pressure control valve 160 connected to the cartridge 152 housed within the cartridge housing 150. The valve 160 acts as a gateway, controlling the flow of compressed CO2 153. Upon activation, the valve 160 opens momentarily to allow a precise amount of CO2 to escape from the cartridge 152. The gas then travels through reinforced tubing 180 and is directed into the main barrel 130, where it is expelled as a high-velocity stream.

For the secondary trigger 126, which operates the insect repellent dispensing mechanism of the device 100, a similar process occurs, but the CO2 153 is routed differently. Pressing the secondary trigger 126 engages a separate channel in the pressure control valve 160, allowing a calculated portion of CO2 to be diverted to the insect repellent reservoir 146 via a tubing 182 as seen in FIG. 3. The CO2 pressurizes the fluid 148 within the reservoir 146, forcing it through the attached nozzle 142 at the end of the secondary barrel 140 via the tubing 182. This results in a fine, controlled spray of insect repellent.

The nozzle 142 is designed to create a uniform spray pattern. In one embodiment, the nozzle 142 is adjustable and may include options for altering the spray angle or mist density. For example, the nozzle 142 can switch between a narrow, focused stream for targeted application and a wide-angle mist for broader coverage.

The insect repellent reservoir 146, which stores the fluid 148, is designed with a transparent or semi-transparent body, allowing users to monitor the fluid levels visually.

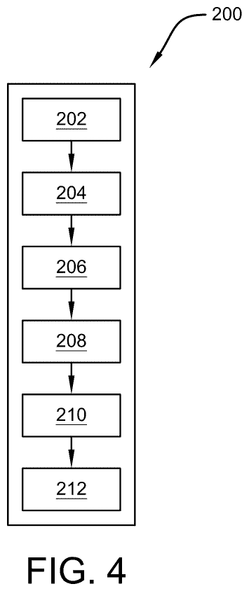

The present invention is also comprised of a method of using 200 the insect control gun device 100, as seen in FIG. 4. First, a device 100 is provided, comprised of a body 110, a handle 120, a main barrel 130, a secondary barrel 140, a cartridge housing 150, and an insect repellent reservoir 146 [Step 202]. Then, a replaceable cartridge 152 containing compressed CO2 153 is installed securely into the cartridge housing 150 by engaging a quick-release mechanism 151 to ensure the cartridge 152 remains firmly seated [Step 204]. Next, the insect repellent reservoir 146 is filled with insect repellent fluid 148 and attached securely to the insect repellent reservoir receiving area 144 using a locking mechanism 145 to create a tight seal [Step 206]. Following this, the toggle button 112 is used to activate and configure the LED light 132 settings, including brightness and wavelength, to attract insects toward the main barrel 130 for precise targeting [Step 208]. When ready for use, the user may press the primary trigger 124 to engage the mechanical linkage system 190, which opens the pressure control valve 160 to release a high-pressure CO2 153 burst through the main barrel 130 [Step 210]. Alternatively, the user may press the secondary trigger 126 to activate the insect repellent dispensing mechanism, diverting CO2 153 through tubing 182 to pressurize the insect repellent fluid 148 within the reservoir 146 and expel it as a fine spray through the nozzle 142 of the secondary barrel 140 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “insect control gun device” and “device” are interchangeable and refer to the insect control gun device 100 of the present invention.

Notwithstanding the foregoing, the insect control gun device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the insect control gun device 100 as shown in the FIGS. are for illustrative purposes only, and that many other sizes and shapes of the insect control gun device 100 are well within the scope of the present disclosure. Although the dimensions of the insect control gun device 100 are important design parameters for user convenience, the insect control gun device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An insect control gun device comprising:
a body;
a handle attached to the body, the handle comprising:
a primary trigger operable to release a CO2 burst;
a secondary trigger operable to activate an insect repellent dispensing mechanism; and
a trigger lock mechanism to prevent unintentional activation of the primary trigger or the secondary triggers;
a main barrel connected to the body;
an insect repellent dispensing mechanism comprising:
a secondary barrel positioned beneath the main barrel;
a nozzle; and
an insect repellent reservoir configured to store an insect repellent fluid and connected to the secondary barrel;
a cartridge housing integrated within the body and configured to house a replaceable cartridge containing a compressed CO2, the cartridge housing comprising a quick-release mechanism to secure the cartridge; and
a pressure control valve connected to the cartridge housing, operable by the primary trigger and the secondary trigger to control CO2 flow to the main barrel and the insect repellent dispensing mechanism.

2. The insect control gun device of claim 1, wherein the main barrel is comprised of an LED light.

3. The insect control gun device of claim 1, wherein the LED light is comprised of an adjustable brightness and an adjustable wavelength.

4. The insect control gun device of claim 1, wherein the secondary barrel is comprised of an adjustable nozzle.

5. The insect control gun device of claim 1, wherein the insect repellent reservoir is transparent or semi-transparent.

6. The insect control gun device of claim 1, wherein the locking mechanism for attaching the insect repellent reservoir comprises a threaded mechanism or a snap-fit mechanism.

7. The insect control gun device of claim 1, wherein the trigger lock mechanism prevents activation of both the primary trigger and the secondary trigger simultaneously.

8. The insect control gun device of claim 1, wherein the quick-release mechanism of the cartridge housing comprises a button or latch.

9. An insect control gun device comprising:
a firearm-shaped body;
a handle attached to the body, the handle comprising:
a primary trigger operable to release a CO2 burst;
a textured grip area;
a secondary trigger operable to activate an insect repellent dispensing mechanism; and
a trigger lock mechanism to prevent unintentional activation of the primary trigger or the secondary triggers;
a main barrel connected to the body;
an insect repellent dispensing mechanism comprising:
a secondary barrel positioned beneath the main barrel;
a nozzle; and
an insect repellent reservoir configured to store an insect repellent fluid and connected to the secondary barrel;
a cartridge housing integrated within the body and configured to house a replaceable cartridge containing a compressed CO2, the cartridge housing comprising a quick-release mechanism to secure the cartridge; and
a pressure control valve connected to the cartridge housing, operable by the primary trigger and the secondary trigger to control CO2 flow to the main barrel and the insect repellent dispensing mechanism.

10. The insect control gun device of claim 9, wherein the insect repellent fluid is comprised of a plant-based repellent, a chemical repellent, or a synthetic insecticide.

11. The insect control gun device of claim 9, wherein the textured grip area is comprised of a thermoplastic elastomer.

12. The insect control gun device of claim 9, wherein the textured grip area is comprised of a silicone.

13. The insect control gun device of claim 9 further comprised of a mechanical linkage system.

14. The insect control gun device of claim 9, wherein the pressure control valve connects to the cartridge.

15. The insect control gun device of claim 13, wherein the pressure control valve connects to the cartridge.

16. The insect control gun device of claim 9 further comprised of a tubing that attaches to the pressure control valve and to the main barrel.

17. The insect control gun device of claim 9 further comprised of a tubing that attaches to the pressure control valve and to the secondary barrel.

18. The insect control gun device of claim 9, wherein the nozzle is adjustable from a stream to a mist.

19. A method of using an insect control gun device, the method comprising the following steps:
providing an insect control gun device comprised of a body, a handle comprised of a primary trigger and a secondary trigger, a main barrel, a secondary barrel, a replaceable cartridge comprised of a compressed CO2, and an insect repellent reservoir;
installing the replaceable cartridge into a cartridge housing integrated within the body by engaging a quick-release mechanism to secure the cartridge;
filling the insect repellent reservoir with an insect repellent fluid and attaching the reservoir to the secondary barrel using a locking mechanism;
activating an LED light integrated into the main barrel to attract insects toward the device;
pressing the primary trigger to engage a pressure control valve connected to the replaceable cartridge, releasing a high-pressure burst of the compressed CO2 through the main barrel to repel or eliminate insects; and
pressing the secondary trigger to divert comprised CO2 through the pressure control valve to the insect repellent reservoir, pressurizing the insect repellent fluid and expelling it through a nozzle in the secondary barrel as a spray.

20. The method of using an insect control gun device of claim 19, wherein the insect control gun device is further comprised of an adjustable nozzle.
